(19) United States
(12) Patent Application Publication
(10) Pub. No.: US 2021/0229363 A1
(43) Pub. Date: Jul. 29, 2021

(54) METHOD FOR DETERMINING AT LEAST ONE PRINTING PROCESS PARAMETER VALUE, COMPUTER-READABLE STORAGE MEDIUM AND ADDITIVE MANUFACTURING INSTALLATION

(71) Applicant: Heraeus Additive Manufacturing GmbH, Hanau (DE)

(72) Inventor: Andreas BAUEREISS, Hanau (DE)

(21) Appl. No.: 16/769,097

(22) PCT Filed: Dec. 12, 2018
(86) PCT No.: PCT/EP2018/084566

§ 371 Date: Jun. 2, 2020

(30) Foreign Application Priority Data
Dec. 22, 2017 (EP) 17210075.2

(51) Int. Cl. B29C 64/393; G01N 25/00; B29C 64/153; B33Y 50/02

(52) U.S. Cl. CPC B29C 64/393; B33Y 50/02; B29C 64/153; G01N 25/00

(57) ABSTRACT

A method for determining at least one printing process parameter value for a beam melting process. The optimum determination of printing process parameter values for a beam melting process is difficult and requires complex simulation processes, which take a lot of time. The problem is solved by the method, which comprises the following three steps: (1) loading from a memory device first and second energy field data which are respectively assigned to energy fields of at least one track of a melting process; (2) determining result energy field data by overlaying the first energy field data with the second energy field data; and (3) determining at least one printing process parameter value for at least one printing process parameter of an additive manufacturing installation using the result energy field data.

### CROSS-REFERENCE TO RELATED APPLICATIONS

This application is a national phase filing of international patent application number PCT/EP2018/084566 filed on Dec. 12, 2018, which claims priority under 35 U.S.C. § 119(a) to European Patent Application No. 17210075.2 filed on Dec. 22, 2017.

### TECHNICAL FIELD

The invention relates to a method for determining at least one printing process parameter value for a beam melting process, a computer-readable storage medium and an additive manufacturing installation.

### BACKGROUND OF THE DISCLOSURE

A multiplicity of methods are known for producing three-dimensional workpieces from one or more liquid or solid materials.

Thus, for example, in what is known as “fused deposition modelling” (FDM), a workpiece is built up layer by layer from a meltable plastic. In this case, a wire-shaped plastic is applied onto a plate in a work region by heating and extrusion using a nozzle. Layers can be applied successively on top of one another by curing the plastic.

In stereolithography (SLA), liquid epoxy resin is poured into a chamber, wherein the surface of the epoxy resin is irradiated in a punctiform manner using a laser such that the epoxy resin cures at the irradiated points. After each exposure step, the cured workpiece is lowered a few millimeters in the epoxy resin, so that a further layer can be printed.

In selective laser sintering (SLS) or selective laser melting (SLM) and electron beam melting (SEBM), a powder bed of a powdered plastic, a metal or a ceramic is initially applied onto a plate in a chamber. The powder bed constitutes a thin layer of the powder used, which is applied, e.g., with a doctor blade. The powder bed therefore consists of loose, unfused particles. After the application of the powder bed, a printed layer is created by selective fusing/sintering of the particles of the powder bed with a laser beam or an electron beam. In the next step, a further powder bed is applied onto the preceding printed layer and selectively fused or sintered in selected regions. The further printed layer created thereby can be connected or fused with a layer lying therebelow. The finished printed product results from the sum of the sequentially applied printed layers. In this case, the edges of all printed layers together form the contour of the printed product.

The selective fusing or sintering preferably takes place by scanning the powder bed using high-energy radiation. In this case, the scanning usually takes place in a linear manner inside a layer, so that individual tracks are created, that is to say melting tracks or sintering tracks. These tracks run at least substantially parallel to one another, wherein the tracks can be connected to one another at alternating ends.

A further method for fusing or sintering the powder bed is multiple, punctiform exposure. In this case, successive melting points or sintering points may also not lie on a line, but rather may be distributed virtually arbitrarily over the powder bed. Optionally, the distribution of the melting points or sintering points takes place according to a fixed pattern, e.g., a chessboard pattern. In the following, a “point” denotes a melting or sintering point.

After the completion of a layer, the building platform is lowered slightly and a new layer is applied. A printed product is therefore created from the sum of the sequentially applied printed layers.

The methods mentioned, i.e., SLS, SLM or SEBM, and methods which operate according to similar principles, are termed beam melting methods or beam sintering methods in the following. Printing of a printed product by a beam melting method therefore operates according to a beam melting process and printing of a printed product by a beam sintering method therefore operates according to a beam sintering process.

It has been established that, in the case of beam melting methods and beam sintering methods in particular, the geometry to be printed is of particular importance for the properties of the printed product. If, for example, material is fused or sintered in closely adjacent regions at short spacings, then local overheating of the material results. Due to the high temperature, the cooling also runs considerably more slowly there relative to other regions in the component, as a result of which the material properties of the printed product are negatively influenced.

A similar behavior can be determined in fusing or sintering of adjacent tracks. An already fused or sintered track therefore has an influence on the track to be fused or sintered next. Overall, the described effects lead to inhomogeneous material properties, which can be expressed, e.g., by an increased fragility of the printed product.

The quality of the printed products therefore varies starkly and leads to unsatisfactory results.

Starting from this prior art, an object of the present invention is to specify a method for determining at least one printing process parameter value for a beam melting process and/or a beam sintering process, a computer-readable storage medium and an additive manufacturing installation, which addresses the previously mentioned disadvantages. In particular, it is an object of the present invention to specify a method that allows printing with substantially homogeneous material properties of the printed product. Furthermore, it is an object of the present invention to specify a method or an additive manufacturing installation, which reduces the reject rate. Furthermore, it is an object of the invention to enable consistent printing results, independent of the geometry to be printed.

### SUMMARY OF THE DISCLOSURE

To achieve these and other objects, and in view of its purposes, the present invention provides a method, a computer-readable storage medium and an additive manufacturing installation according to the disclosure.

In particular, the objects are achieved by a method for determining at least one printing process parameter value for a beam melting process and/or a beam sintering process, having the following three steps:
loading from a memory device first and second energy field data, which are respectively assigned to, particularly adjacent, energy fields of at least one region, particularly at least one track and/or at least one point, preferably of ten tracks, of a melting process or a sintering process;
determining result energy field data by, particularly numerically, overlaying the first energy field data with the second energy field data; and
determining at least one printing process parameter value for at least one printing process parameter of an additive manufacturing installation using the result energy field data.

It is a core of the invention that the energy fields of already fused or sintered regions are taken into account during fusing or sintering of the next region. In the following, the fusing or the sintering of a region is in summary termed printing a region, wherein both methods are always meant in this case. During the printing of a region, there is a temperature rise in the region itself and also in its surroundings. If more than two regions lying next to one another are printed, then there is an overlaying of the energy fields of the first two regions at the point at which the third region should be printed. Due to changing environmental conditions, particularly a changing temperature of the material to be processed, the printing with constant printing process parameter values does not lead to optimum results or constant product properties. It is therefore necessary to determine printing process parameter values for each region individually, wherein even inside a region, the printing process parameter values can be changed as a function of the geometry of the printed product to be printed.

One region may in particular specify at least one track and/or at least one point.

A further aspect of the invention lies in selecting constant values, which lead to predictable good results, for printing process parameters, the values of which cannot be changed during the printing process. In particular, a printing process parameter value, at which at least one product property corresponds to a requirement profile, can be selected for the printing process parameter. In this case, the temperature rise is taken into account during the selection of the printing process parameter value.

In one embodiment, a multiplicity of energy field data records, particularly ten energy field data records, can be loaded, wherein the overlaying is realized using the multiplicity of energy field data records, and wherein a stationary state is set for the result energy field data.

The energy field data may respectively specify at least substantially one thermal energy, particularly an inner energy. In other embodiments, the energy field data may specify the enthalpy of an assigned region. In a further embodiment, the chemical potential in the case of the inner energy may remain unconsidered.

The thermal behavior of the material may be expressed for a region by energy field data in each case. By determining result energy field data, the temperature of the material to be processed may be predicted in the third region, so that a printing process parameter value can be selected in accordance with the thermal behavior or in accordance with this temperature. Thus, it is possible to achieve constant and predictable printing results.

The regions mentioned may be regions of a single layer and/or regions of different layers. This is advantageous, as the thermal behavior of course also radiates on other layers, particularly layers lying therebelow and/or thereabove.

In an embodiment, the method comprises a calculation of at least one process window map for at least one printing process parameter using the result energy field data, wherein the at least one printing process parameter value can be determined using the at least one process window map.

The at least one process window map may specify mapping of the at least one printing process parameter onto at least one product property.

A process window map makes it possible to quickly determine a product property value for given printing process parameter values. Due to a process window map, it is likewise possible to determine a corresponding printing process parameter value for a desired product property value. Due to the calculation of a process window map, it is therefore possible to guarantee product properties. In an embodiment, process window maps for at least one printing process parameter value, which is constant over the printing process, can be correlated with at least one product property. Then, the at least one printing process parameter value can be determined in such a manner that the at least one product property lies in a preferred range.

Often, printing process parameters cannot be set as desired during the process for technical or physical reasons. For example, the change of the beam power is connected with a certain reaction time and changes to the beam velocity are subject to the inertia of the beam optics. Therefore, it is advantageous if a constant printing process parameter value is selected, which leads to good product properties over the entire printing process.

A product property may in particular specify the product density, the porosity, the microstructure, the surface roughness, the residual stress, the distortion, the alloy composition, the process time, a susceptibility to cracking and/or the production costs.

In an embodiment, the overlaying of the first energy field data with the second energy field data comprises the determination of a beam contact point temperature, wherein the beam contact point temperature in particular specifies the temperature on the surface of a product at a certain time at a certain position.

By determining a beam contact point temperature, the temperature can be determined at the position at which an energy beam, e.g., a laser beam or electron beam, hits the material to be fused. Thus, the printing process parameter value can be adapted to the beam contact point temperature, as a result of which better melting results or sintering results are achieved.

Furthermore, the first and/or the second energy field data can be loaded using the beam contact point temperature. Precisely those energy field data, which correspond to energy fields which are measured, created or simulated at the certain beam contact point temperature, can then be loaded. Subsequently, during determination of the result energy field data, an energy content corresponding to the beam contact point temperature can be removed or drawn from the energy field data.

Thus, the energy field data, which are to be loaded, can be better determined, as a result of which better melting results or sintering results are achieved.

In an embodiment, the method comprises the following four steps:
creating simulation data by simulating at least one energy field;
adapting the simulation data to experimental data, which specify results of fusing experiments and/or sintering experiments, particularly by executing a random sample consensus (RANSAC) algorithm and/or by cross correlation;
creating the first energy field data using the adapted simulation data; and
storing the first energy field data in the memory device.

In the described embodiment, the energy field data are determined using experimental data and simulation data. Particularly good results may be achieved by combining the data from experiments and simulations. The simulation data are in this case adapted to the experimentally determined data particularly efficiently by cross correlation.

In an embodiment, a base temperature can respectively be assigned to the first and/or the second energy field data, particularly stored, wherein the result energy field data are determined while taking the respective base temperature into account.

The base temperature is determined, e.g., by the removal or drawing of the energy corresponding to the beam contact point temperature. By assigning a base temperature to the energy field data, the influence, which a melting process or sintering process has, can be determined more precisely. Thus, the result energy field data may also be determined more precisely, as a result of which the product quality increases.

In an embodiment, the creation of the simulation data comprises:
determining at least first and second raw simulation data, which can respectively specify an energy field (E1, E2) at different times and/or using at least one different printing process parameter value (25) and/or different base temperature; and
creating the simulation data (21) by numerically overlaying the at least first and second raw simulation data for a time and/or at least one printing process parameter value and/or a base temperature, which differs or may differ from the times, printing process parameter values and/or base temperatures assigned to the raw simulation data.

By overlaying a plurality of simulated raw simulation data, it is possible to determine simulation data for times or configurations, which are not explicitly simulated. The overlaying leads to a type of interpolation of the simulated data. As a result, on the one hand much computing time is saved in that fewer energy fields have to be simulated and, on the other hand, less memory is consumed for storing simulation data.

In an embodiment, the first and the second energy field data are stored as matrices, particularly as vectors, preferably as list or as array.

The memory options mentioned offer a particularly efficient storage of the energy field data, which allow simple loading/saving and/or manipulation of the data.

In an embodiment, the method comprises determination of result temperature field data using the result energy field data, wherein the process window map can be determined using the result temperature field data.

By determining result temperature field data, which may specify the thermal behavior directly, it is possible to determine the printing process parameter value very quickly.

A series of different printing process parameters are conceivable. In an embodiment, the at least one printing process parameter specifies:
a beam diameter;
a beam power;
a beam velocity;
a spacing of adjacent tracks or adjacent points;
a nominal powder layer thickness;
a grain size of a powder to be fused or to be sintered, and/or
an installation space temperature.

In an embodiment, the method comprises a control of an additive manufacturing installation for manufacturing a product, using the at least one printing process parameter value.

It is therefore possible to control an additive manufacturing installation directly, using the printing process parameter value. To this end, in an embodiment, the method comprises transmitting the printing process parameter value to an additive manufacturing installation, particularly via the internet, an intra- and/or extranet.

It is therefore not necessary that a computer or mobile terminal device, such as a smartphone or laptop, is present directly in the vicinity of the additive manufacturing installation. Rather, distributed systems can be built, which make it possible to control a multiplicity of additive manufacturing installations from a computer.

In an embodiment, the method comprises creating a metamodel, particularly by the interpolation of values of a process window map comprising discrete values, wherein the metamodel specifies a relationship between at least one product property and at least one printing process parameter, wherein the determination of the at least one printing process parameter value can be executed using the metamodel.

A process window map may illustrate a discrete image, wherein a product property value is assigned to a single printing process parameter value. Therefore, only previously determined values can be queried. By interpolating these values, a metamodel can then be created, which makes it possible to query any desired values. A metamodel may therefore be considered as a continuous function, particularly an injective or bijective function, which assigns a product property value to a printing process parameter value.

By creating the metamodel, considerably finer gradations can be undertaken in the parametrization of an additive manufacturing installation.

The objects are further achieved by a computer-readable storage medium, which contains instructions, which cause at least one processor to implement a method, as was described previously, if the instructions are executed by the at least one processor.

The objects are likewise achieved by an additive manufacturing installation, having the following:
a memory device, particularly a storage medium, as described previously;
a processor, which is constructed to execute instructions saved in the memory device; and
a radiation source,
   wherein the processor is constructed to configure the radiation source using a printing process parameter value.

Similar or identical advantages result, as have already been described in connection with the method.

It is to be understood that both the foregoing general description and the following detailed description are exemplary, but are not restrictive, of the disclosure.

### BRIEF DESCRIPTION OF THE DRAWING

Exemplary embodiments of the invention are explained in more detail in the following on the basis of figures. In the figures:

FIG. 1 shows a principle illustration of an additive manufacturing method;

FIG. 2 shows a schematic illustration of an additive manufacturing installation;

FIG. 3 shows a schematic illustration, illustrating the overlaying of energy fields of melting tracks;

FIG. 4 shows a flow chart, illustrating the storage of energy field data in a database;

FIG. 5 shows a flow chart, illustrating the determination of a printing process parameter value;

FIG. 6 shows a schematic illustration of a process window map; and

FIG. 7 shows a flow chart, illustrating a method for controlling a manufacturing installation.

### DETAILED DESCRIPTION OF THE DISCLOSURE

In the following, the same reference numbers are used for the same or similar items.

The following exemplary embodiments describe the printing of a plurality of tracks. In the context of this invention, all described concepts can also be applied to the printing of individual points.

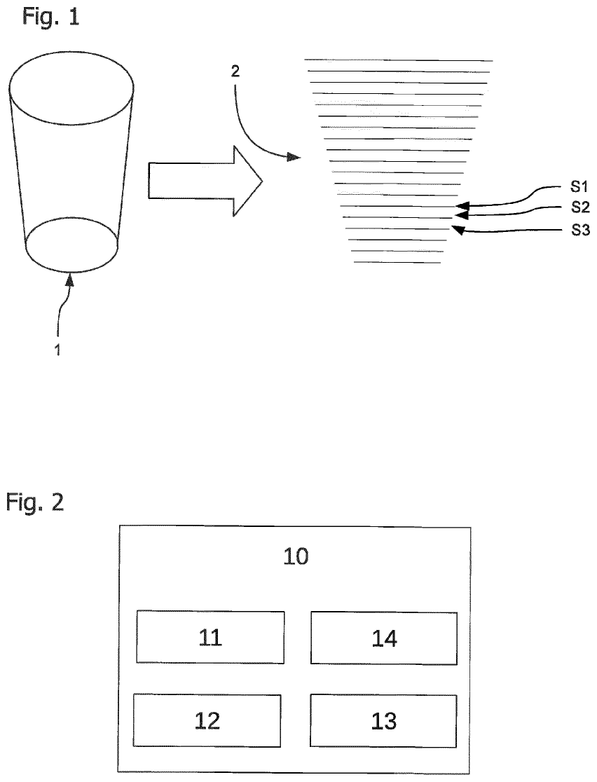

FIG. 1 shows the printing of an object 1 schematically. In this case, object data are provided, which describe the object 1 as CAD data. Various data formats, such as IGES or STL, may be used to this end. The object data are subsequently “sliced.” That means that software breaks object data down into a multiplicity of layers to be printed. In an exemplary embodiment, machine-readable code is created subsequently, e.g., in what is known as a build processor, from the “sliced” object data, which code can be read by an additive manufacturing installation 10 (see FIG. 2), e.g., a 3D printer.

The printed product 2 is built up during printing from a multiplicity of printed layers S1, S2, S3. For example, in the SLS method, as already described above, a printed layer S1, S2, S3 is always produced by the selective fusion of a powder. The melting paths created in this case are arranged in just such a manner that a stable material composite is created. Thus, the printed product 2 is built up layer by layer.

FIG. 2 shows a schematic illustration of an additive manufacturing installation 10, which can be used for creating a printed product 2, as is described with respect to FIG. 1.

The additive manufacturing installation 10 comprises at least one processor 12, a memory device 11, a lifting device 14 and a radiation source 13. In a further exemplary embodiment, a network adapter is further provided, which is constructed to connect the additive manufacturing installation 10 to the internet, an intranet or an extranet. In this case, various parameter values, such as printing process parameter values can be received via the network. The additive manufacturing installation 10 can be parametrized or configured by the received parameter values. Thus, on the one hand, it is possible to receive parameter values from a server, on the other hand, it is also possible to receive parameter values from a different additive manufacturing installation. Thus, it is easily possible for an operator of more than one additive manufacturing installation 10 to copy settings to all or a portion of their installations.

The memory device 11 is constructed to save instructions, which, when executed by the processor 12, cause the processor 12 to control the radiation source 13. The radiation source 13 may be, e.g., a laser source or an electron beam source. The additive manufacturing installation 10 of FIG. 2 may therefore be a manufacturing installation for a beam melting process or for a sintering process. The memory device 11 is further constructed for saving printing process parameter values, which parametrize the control of the radiation source 13. For example, the printing process parameter values may specify the beam diameter, the beam power and/or a spacing of adjacent tracks. Furthermore, a beam velocity, that is to say the velocity with which the beam moves over the powder to be fused, can be specified by a printing process parameter. In addition to printing process parameters that are assigned to the radiation source 13, further printing process parameters are provided, which are assigned to the lifting device 14. For example, a printing process parameter value may specify the nominal powder layer thickness of the powder bed.

In the following, the invention is described in detail for printing different tracks. All exemplary embodiments or embodiments may however also be applied for the printing of individual points. The terms “points” and “tracks” are therefore essentially to be understood as equivalent in relation to the invention.

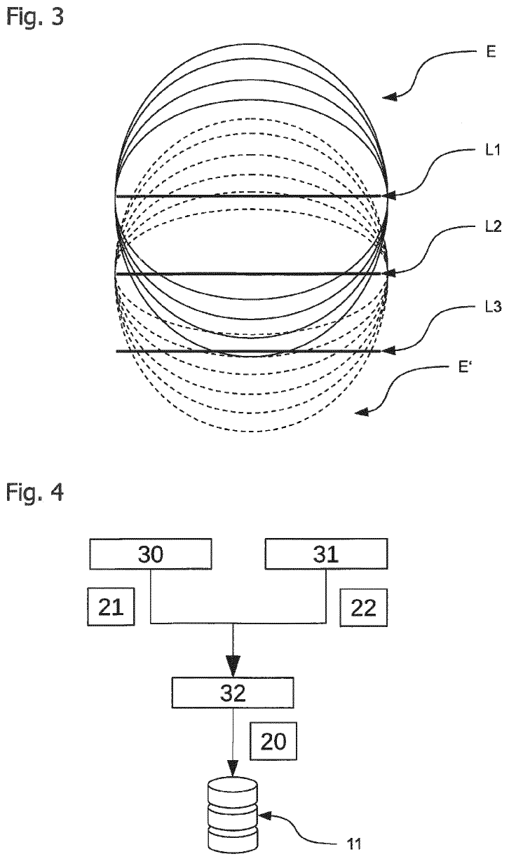

FIG. 3 shows a schematic illustration of three tracks L1, L2, L3. The tracks L1, L2, L3 are applied one after the other, wherein the track L1 is applied prior to the track L2. The track L3 is in turn applied temporally after the track L2. During application of the tracks L1, L2, L3, a temperature-dependent energy field E, E′ is created for each of the tracks L1, L2, L3. For a better overview, only the energy fields E, E′ of the tracks L1, L2 are illustrated in FIG. 3. When the first track L1 is applied, then the temperature of the material to be melted or to be sintered or the material in the track L1 itself and surroundings around the track L1 is increased. Thus, prior to the application of the track L2, the temperature of the material to be melted in the track L2 is increased, as the tracks are adjacent or lie close together.

The same applies in the case of track L3, wherein the influences of the melting processes or sintering processes of the tracks L1 and L2 are to be taken into account, which have a common influence on the temperature of the material of the track L3 to be melted or sintered. The invention is based on the idea of adapting the printing process parameters in accordance with the melting processes or sintering processes which have taken place in the surroundings of a track L1, L2 which is to be applied. For example, the beam intensity can be reduced if the material to be melted or sintered is already very hot. It is the aim in most cases to ensure uniform material properties of the finished printed product 2.

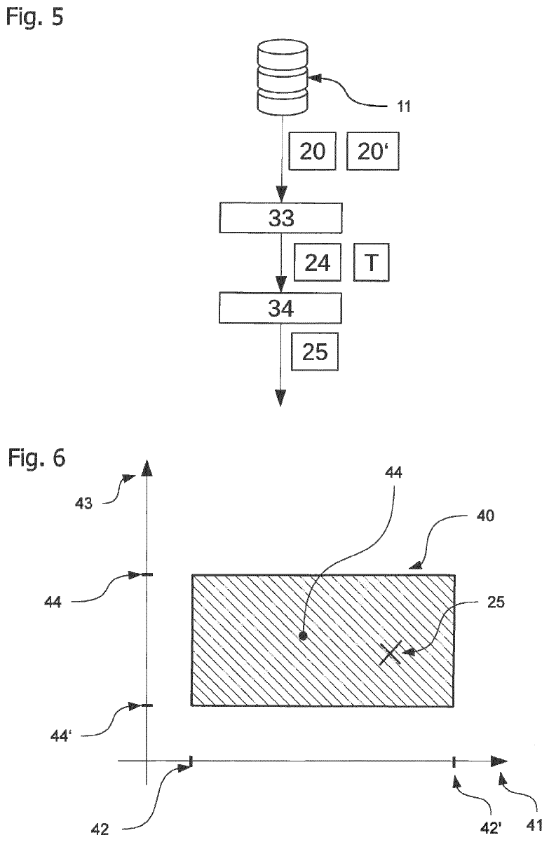

The invention is now explained in more detail on the basis of FIGS. 4 and 5. FIG. 4 shows a flow chart, which specifies a method for saving energy field data 20. The application of an individual track L1, L2, L3 is simulated in a simulation step 30. In this case, the enthalpy in particular is simulated by known numerical simulation methods, e.g., methods which are based on the Lattice Boltzmann method. In a further exemplary embodiment, for simplification, the compressibility of the Navier-Stokes equations and the convection-diffusion equation is disregarded. That is to say, the simulation is reduced to the simulation of the inner energy. This simulation can also be reduced further if the chemical potential is not also simulated. Even in the last-mentioned case, the simulation still delivers sufficiently precise results. Thus, there are various simulation methods, which can be simplified, depending on the available computing power.

In an exemplary embodiment, the raw simulation data obtained by the simulation comprise the set of printing process parameter values used and a base temperature for each track, wherein energy field data are calculated for the corresponding printing process parameter values and base temperatures at discrete times. That is to say, a list of energy field data records is created for an individual track.

In an exemplary embodiment, an object of an object-oriented programming language is created for the raw simulation data of an individual track, wherein the object may have data and functions as properties. The objects are in turn saved in a corresponding data structure.

The raw simulation data are queried from the data structure using a query function. In this case, raw simulation data are queried as a function of a time and a volume in space, using the query function. Querying the raw simulation data comprises the interpolation of the saved raw simulation data, so that the resolution of the data returned by the query function may deviate from the resolution of the saved raw simulation data.

Furthermore, the query function is designed in such a manner that it returns the raw simulation data for two consecutive times for each time queried. This is advantageous, as the queried time does not usually correspond exactly to the calculated times. Of course, it is therefore also possible that the raw simulation data are returned for more than two times. For a value X, which specifies for how many times raw simulation data should be returned, in an exemplary embodiment, for a time t, the data for the times t−X/2 to t+X/2 are returned.

In the same way, the raw simulation data, different beam contact temperatures and printing process parameter values may differ from the saved values, so that here also, at least two data records are returned.

If raw simulation data for precisely two times, two beam contact temperatures and two printing process parameter values, such as two power values of an electron beam source, are returned, then eight data records in total are therefore returned.

In an exemplary embodiment, the returned raw simulation data are additionally adapted to a common surface. This may be necessary, because, e.g., a melting bath is moving in accordance with the principles of hydrodynamics.

Each of the data records of raw simulation data therefore usually defines a different surface. For the eight or more data records, initially one common surface may be determined by a weighted average value. Subsequently, the eight data records are skewed in such a manner that they specify a surface which corresponds to the common surface.

Subsequently, these eight data records can be overlayed numerically by raw simulation data and thus form the simulation data 21.

The saving of the raw simulation data is very complex. It is therefore possible to simulate only a short time period and to carry out an extrapolation for further times. As a result, the requirements for necessary memories can be kept low. In this case, the extrapolation corresponds to a spatial stretching or expansion of the last simulated energy field by a factor which is proportional to the thermal diffusion length at the given time.

Furthermore, the illustrated method comprises an experimental step 31, in which tracks L1, L2, L3 are applied individually. The energy fields of the tracks L1, L2, L3 can be determined by measurements. In this case, the tracks L1, L2, L3 applied in the experiments are applied with the same printing process parameter values as were used in simulation step 30, so that the simulation of a track L1, L2, L3 can be assigned to a track L1, L2, L3 of the experimental step 31. As experiments are very complex, in an exemplary embodiment, only a portion of the simulation data are also determined experimentally. In particular, energy field data for 16 tracks are determined experimentally and the energy fields for 500-4,000 tracks.

The simulation data 21 are adapted in an adaptation step 32 to experimental data 22, which specify at least one experimentally determined energy field. The energy field of an experiment can be determined in an embodiment, e.g., by measuring the cross section of a track in that the fusing line is correlated with the isothermal line of the solidus line and/or liquidus line of corresponding simulation data.

The adaptation can subsequently be carried out by cross correlation. Also, model finding is possible by means of a RANSAC algorithm. Thus, in the adaptation step 32, energy field data 20 are created taking the experimental and the simulation data 21, 22 into account. This ensures a particularly good robustness of the method.

The energy field data 20 created in the adaptation step 32 are saved for later use in the database 11. The method of FIG. 4 is carried out for a very large number of tracks L1, L2, L3, wherein printing process parameters such as the material to be fused or to be sintered or the printing process parameters mentioned above are varied. The method of FIG. 4 can be executed at any desired time prior to the actual printing process. Also, the database 11 can be provided via a web server, so that the data can be queried from any desired location at any time, for example via a corresponding application programming interface (API).

The use of the energy field data 20 created by the method of FIG. 4 is now described with reference to FIG. 5. If a new printed product 2 should be printed, then standard settings for the printing process parameters are determined for the first track to be printed, which printing process parameters arise from a base temperature of the material to be fused or sintered. In this case, even for the first track L1, a process window map 40 can be called upon, as is described in connection with FIG. 6.

After the application of the first track L1, before a second track L2 is applied, energy field data 20 are read from the database 11, which data are created by at least substantially identical printing process parameters as the first track L1. As a result, it is possible to determine the influence of the first track L1 on the region in which the second track L2 should be applied. For example, a temperature rise in the region of the second track L2 can be taken into account during the choice of the beam intensity. That is to say a printing process parameter value can accordingly be adapted to the energy field data 20 of the adjacent track L1.

FIG. 5 in particular shows the case that two tracks L1, L2 have already been applied and now a third track L3 should be applied.

First and second energy field data 20, 20′ are read from the database 11 for applying the third track L3. The first and second energy field data 20, 20′ are respectively assigned to one of the already applied tracks L1, L2. In a determination step 33, result energy field data 24 are determined by numerical overlaying of the first and second energy field data 20, 20′. It is therefore determined what combined influence the energy fields E, E′ assigned to the first and second energy field data 20, 20′ have on the region in which the third track L3 should be applied. In this case, it is determined, in particular, how the temperature T develops temporally in the region of the third track L3.

A printing process parameter value 25 is determined in step 34 based on the temperature T and the result energy field data 24. For example, at an increased temperature T compared to the base temperature, a lower beam power and/or an increased beam velocity can be set as the printing process parameter value 25 compared to a previously printed track.

Process window maps 40 can therefore be used for selecting printing process parameter values 25. FIG. 6 shows a schematic illustration of a process window map 40. FIG. 6 shows a coordinate system, which is spanned by the two axes 43, 41. The process window map 40 specifies the relationship of individual values of the printing process parameters 41 to product property limit values 44, 44′. Only one product property 43 is represented in the exemplary embodiment illustrated.

In other exemplary embodiments, a process window map 40 may specify a multi-dimensional parameter range, which specifies the relationship of a multiplicity of printing process parameters to a multiplicity of product properties.

A process window map 40 may be created in a different manner. For example, a process window map 40 can be created experimentally. For experimentally determining a process window map 40, a multiplicity of printed products 2 are printed using different printing process parameter values 25. The printed products 2 can then be investigated in a laboratory, so that the product property values are determined precisely.

In an exemplary embodiment, the process window map 40 is determined by simulation methods. Such a simulation can be carried out in the case of known relationships of printing process parameters 41 to product properties 43. Thus, expensive experiments can be avoided.

In a further exemplary embodiment, the process window map 40 is created using result temperature field data 24. In this case, during creation of the process window map 40, the influence, e.g., of temperature of adjacent tracks L1, L2 on the track L3 to be applied is taken into account.

A process window map 40 constitutes a discrete quantity of printing process parameter values 25 and associated product property values. Furthermore, the process window map 40 may contain information about which printing process parameter values 42, 42′ specify an acceptable quality range between the produce property limit values 44, 44′. Printing process parameter values, which lie outside the quality range, lead to unsatisfactory products. A quality range is specified, e.g., by two or more product property limit values 44, 44′. The product property limit values 44, 44′ then specify the outer limits of the quality range.

A metamodel 45 can further be created from the process window map 40. The discrete points of the process window map 40 may be transformed into a continuous metamodel 45 by known methods, e.g., splicing interpolation or training of a neural network.

Thus, it is also possible that the printing process parameter value 25 is selected using a metamodel 45.

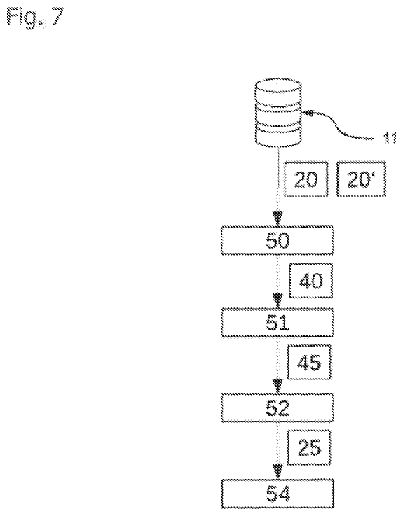

FIG. 7 shows a further exemplary embodiment, in which the additive manufacturing installation 10 is controlled by a printing process parameter value 25. Initially, two sets of energy field data 20, 20′ are read anew from the database 11, which data can be assigned to respectively adjacent tracks L1, L2 of the track L3 to be applied.

In step 50, the process window map 40 is created using the energy field data 20, 20′. In this case, in step 50, the result energy field data 24 are determined, which can be used as described in relation to FIG. 6 to create the process window map 40. In step 51, the metamodel 45 is calculated by interpolating the values from the process window map 40.

In step 52, the printing process parameter value 25 for the application of the individual track L3 is determined by the metamodel 45. In this case, a desired product property is determined by the user and a corresponding printing process parameter value 25 is determined.

In step 54, an additive manufacturing installation 10 is set up and controlled using the determined printing process parameter value 25.

Although illustrated and described above with reference to certain specific embodiments and examples, the present disclosure is nevertheless not intended to be limited to the details shown. Rather, various modifications may be made in the details within the scope and range of equivalents of the claims and without departing from the spirit of the disclosure.

1. A method for determining at least one printing process parameter value for a beam melting process and/or a beam sintering process, comprising the following steps:
loading from a memory device first and second energy field data, which are respectively assigned to energy fields of at least one region of a melting process or sintering process;
determining result energy field data by overlaying the first energy field data with the second energy field data; and
determining at least one printing process parameter value for at least one printing process parameter of an additive manufacturing installation using the result energy field data.

2. The method according to claim 1, further comprising
calculationg at least one process window map for at least one printing process parameter using the result energy field data, wherein the at least one printing process parameter value is determined using the at least one process window map.

3. The method according to claim 2, wherein the at least one process window map specifies mapping of the at least one printing process parameter onto at least one product property.

4. The method according to claim 1, wherein the overlaying of the first energy field data with the second energy field data includes determinng beam contact point temperature that specifies the temperature on the surface of a product at a certain time at a certain position.

5. The method according to claim 1, wherein the first energy field data and the second energy field data respectively specify at least substantially one thermal energy.

6. The method according to claim 1, further comprising:
creating simulation data by simulating at least one energy field;
adapting the simulation data to experimental data, which specify results of fusing experiments and/or sintering experiments, by executing a random sample consensus (RANSAC) algorithm and/or by cross correlation;
creating the first energy field data using the adapted simulation data; and
storing the first energy field data in the memory device.

7. The method according to claim 1, further comprising assigning a base temperature to the first and/or the second energy field data and wherein the result energy field data are determined based upon the base temperature.

8. The method according to claim 7, wherein the step of creating the simulation data comprises:
determining at least first and second raw simulation data, which respectively specify an energy field of a simulated melting process at different times and/or using at least one different printing process parameter value and/or different base temperature; and
creating the simulation data by numerically overlaying the at least first and second raw simulation data for a time and/or at least one printing process parameter value and/or a base temperature, which differ or differs from the times, printing process parameter values and/or base temperatures assigned to the raw simulation data.

9. The method according to claim 1, further comprising storing the first and the second energy field data as matrices.

10. The method according to claim 2, further comprising determinng result temperature field data using the result energy field data, wherein the process window map is calculated using the result temperature field data.

11. The method according to claim 3, wherein the product property specifies a product density, a porosity, a microstructure, a surface roughness, a residual stress, a distortion, an alloy composition, a process time, a susceptibility to cracking, a grain size of a powder to be fused, and/or production costs.

12. The method according to claim 3, wherein the at least one printing process parameter specifies
a beam diameter;
a beam power;
a beam velocity;
a spacing of adjacent tracks or adjacent points;
a nominal powder layer thickness; and/or
an installation space temperature.

13. The method according to claim 1, further comprising using the at least one printing process parameter value to control the additive manufacturing installation for manufacturing a product.

14. The method according to claim 1, further comprising transmitting the at least one printing process parameter value to the additive manufacturing installation.

15. The method according to claim 3, further comprising creating a metamodel that specifies a relationship between the at least one product property and the at least one printing process parameter and wherein the determination of the at least one printing process parameter value uses the metamodel.

16. A computer-readable storage medium comprising instructions configured to be executed by at least one processor to implement the method according to claim 1.

17. An additive manufacturing installation comprising:
a memory device including instructions;
a processor configured to execute the instructions of in the memory device to implement the method according to claim 1; and
a radiation source,
wherein the processor configures the radiation source using the at least one printing process parameter value.

18. The method according to claim 9, wherein the first and the second energy field data are stored as a list or as an array of vectors.

19. The method according to claim 14, wherein the at least one printing process parameter value is transmitted via the internet, an intranet, and/or an extranet.

20. The method according to claim 15, wherein the metamodel is created by interpolating values of the at least one process window map having discrete values.
